(19) United States
(12) Patent Application Publication
(10) Pub. No.: US 2010/0158040 A1
(43) Pub. Date: Jun. 24, 2010

(54) JOINING PROCEDURE

(75) Inventors: David Harle, Glasgow (GB); Christos Tachtatzis, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow (GB)

(21) Appl. No.: 12/600,602

(22) PCT Filed: May 9, 2008
(86) PCT No.: PCT/GB2008/001609

§ 371 Date: Feb. 4, 2010

(30) Foreign Application Priority Data
Jun. 1, 2007 (GB) 0710561.2

(51) Int. Cl. H04L 12/43

(52) U.S. Cl. 370/458

(57) ABSTRACT

There is provided a method of operating a device to join a network, the network having a plurality of superframes, each superframe being divided into slots, the method comprising transmitting a beacon frame in a first slot of a first superframe; wherein, if a collision occurs in the first slot, selecting a second slot from a group comprising the first slot and a plurality of slots occurring after the first slot; and transmitting a further beacon frame in the second slot in a subsequent superframe.

### TECHNICAL FIELD OF THE INVENTION

The invention relates to a method and apparatus for improving the procedure used by devices to join a network, and in particular ultra wideband networks.

### BACKGROUND TO THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 per cent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

A sequence of three frequencies on which each data symbol is sent represents a Time Frequency Code (TFC) channel. A first TFC channel can follow the sequence 1, 2, 3, 1, 2, 3 where 1 is the first sub-band, 2 is the second sub-band and 3 is the third sub-band. Second and third TFC channels can follow the sequences 1, 3, 2, 1, 3, 2 and 1, 1, 2, 2, 3, 3 respectively. In accordance with the ECMA-368 specification, seven TFC channels are defined for each of the first four band groups, with two TFC channels being defined for the fifth band group.

The technical properties of ultra-wideband mean that it is being deployed for applications in the field of data communications. For example, a wide variety of applications exist that focus on cable replacement in the following environments:

communication between PCs and peripherals, i.e. external devices such as hard disc drives, CD writers, printers, scanner, etc.

home entertainment, such as televisions and devices that connect by wireless means, wireless speakers, etc.

communication between handheld devices and PCs, for example mobile phones and PDAs, digital cameras and MP3 players, etc.

In wireless networks such as UWB networks one or more devices periodically transmit a Beacon frame during a Beacon Period. The main purpose of the Beacon frame is to provide for a timing structure on the medium, i.e. the division of time into so-called superframes, and to allow the devices of the network to synchronize with their neighbouring devices.

The basic timing structure of a UWB system is a superframe as shown in FIG. 2. A superframe according to the European Computer Manufacturers Association standard (ECMA), ECMA-368 2^{nd} Edition, consists of 256 medium access slots (MAS), where each MAS has a defined duration e.g. 256 μs. Each superframe starts with a Beacon Period, which lasts one or more contiguous MAS's. Each MAS forming the Beacon Period comprises three Beacon slots, with devices transmitting their respective Beacon frames in a Beacon slot. The start of the first MAS in the Beacon Period is known as the Beacon Period Start Time (BPST). A Beacon group for a particular device is defined as the group of devices that have a shared Beacon Period Start Time (±1 μs) with the particular device, and which are in transmission range of the particular device.

In ECMA-368, data transmissions from communicating devices are carried in an explicit group of Medium Access Slots (MAS) over a single assigned time frequency code (TFC) channel. The mapping between devices and the MAS to be used (i.e. the indications of which device pairs will be communicating and in which Medium Access Slot(s)) is communicated by each device in the Beacon Period at the start of each superframe. Devices may also exchange data in unreserved MASs if the MASs are not Hard DRP reserved, or if Hard DRP or private reserved MASs are relinquished.

As described above, in a Beacon-coordinated Medium Access Control protocol such as ECMA-368, each device in the network transmits a Beacon frame in an allocated Beacon slot of a Beacon Period.

FIG. 3 illustrates the joining procedure for a plurality of devices in a Beacon Period for consecutive superframes. In this Figure, it is assumed that each of the devices are in range of each other.

FIG. 3(a) shows the content of a Beacon Period in a superframe x. The first two slots are signalling slots and are not allocated to any devices. The next three slots comprise the Beacon frames of three devices, Device 1, Device 2 and Device 3 respectively which have previously joined the network. Other slots in the Beacon Period remain unused during this superframe. It will be appreciated that the number of empty slots in the Beacon Period is variable. In accordance with the ECMA-368 standard, the number of empty slots after the last occupied slot can be, at most, mBPExtensionSlots subject to the constraint that the Beacon Period length does not exceed mMaxBPLength slots.

When new devices (Device 4 and Device 5 in FIG. 3(b)) want to join the target channel, they must listen for at least one superframe (for example superframe x) before they randomly select an unallocated slot in the next Beacon Period and transmit their Beacon frame. The devices select a slot from a fixed-length “window” of slots of length mBPExtension after the highest numbered unavailable Beacon slot observed in the last superframe (superframe x) and within mMaxBPLength after the BPST. Thus, as shown in FIG. 3(b), the devices can select a slot from a window starting from the sixth slot (slot 5) in which to transmit their Beacon frame. In this example, Device 4 selects the ninth slot (slot 8) in the Beacon Period of superframe x+1 to transmit its Beacon frame, and Device 5 selects the eleventh slot (slot 10) in the Beacon Period to transmit its Beacon frame.

In subsequent superframes, the Beacon Period is contracted, which means that all occupied Beacon Period slots are consolidated contiguously from the start of the frame. In accordance with the ECMA-368 standard, a device will consider its Beacon frame to be moveable if in the current superframe it finds at least one available Beacon slot between the signalling slots and its own Beacon slot. If the device is not involved in a Beacon collision or a Beacon Period merge, it shall shift its Beacon frame into the earliest available Beacon slot in the following superframe, if, in the latest mMaxLostBeacons+1 superframes its Beacon frame has been encoded as moveable and all Beacon slots after the device's own and within the device's Beacon Period length have been encoded as non-moveable.

Thus, in the illustrated example, device 5 will move its Beacon frame to Beacon slot 5 after mMaxLostBeacons+1=4 superframes (i.e. in superframe x+5) and device 4 will move its Beacon frame to Beacon slot 6 after mMaxLostBeacons+1=5 superframes (i.e. in superframe x+6).

Thus, by superframe x+7 (as shown in FIG. 3(c)), the Beacon signals for Devices 1 to 3, 5 and 4 are transmitted in the first five slots after the two signalling slots of the Beacon Period respectively.

In superframe x+8, as shown in FIG. 3(d), a further two devices, Device 6 and Device 7, attempt to join the network. Again, both devices select a slot within the mBPExtension length window. However, both devices select the same slot (slot 8) in the Beacon Period in which to transmit their Beacon frame, which means that the Beacon frames collide.

When such collisions are detected by the joining devices (following the ECMA-368 Collision Detection Mechanism), these devices are required to “redraw” slots from a new window of a fixed length in the next superframe (the length of the window is mBPExtension slots after the last unavailable Beacon slot but within mMaxBPLength after the BPST. As this window starts after the highest unavailable slot, the slot(s) corresponding to the slots in the superframe in which the collision(s) occurred are not used by any of the colliding devices in the further attempts to join the network.

The “redraw” process extends the Beacon Period in the next or a subsequent superframe, and can result in the extension of the Beacon Period to the maximum allowed Beacon Period length (mMaxBPLength).

If this happens and a collision occurs in the last possible slot (slot=mMaxBPLength=96), it will no longer be possible to extend the Beacon Period, and any remaining devices wishing the join the network will be unable to be allocated a slot in the Beacon period. Thus the devices must wait until the Beacon Period is contracted. After contraction, the range of slots occupied by active devices will have been minimised and further extension windows are now possible and devices wishing to join can attempt to access slots as before.

In such standard mechanisms, any slots that are subject to contention and collisions are effectively wasted during any subsequent Beacon Period extension, as they are unallocated but also unavailable for selection.

Therefore, there is a need for a joining procedure that overcomes the disadvantages associated with the conventional procedure described above.

### SUMMARY OF THE INVENTION

According to a first aspect of the invention, there is provided a method of operating a device to join a network, the network having a plurality of superframes, each superframe being divided into slots, the method comprising transmitting a beacon frame in a first slot of a first superframe; wherein, if a collision occurs in the first slot, selecting a second slot from a group comprising the first slot and a plurality of slots occurring after the first slot; and transmitting a further beacon frame in the second slot in a subsequent superframe.

According to a second aspect of the invention, there is provided a device for use in a network, the network having a plurality of superframes, each superframe being divided into slots, the device comprising transmission means for transmitting a beacon frame in a first slot of a first superframe; and selection means, responsive to detecting a collision in the first slot, for selecting a second slot from a group comprising the first slot and a plurality of slots occurring after the first slot; wherein the transmission means is adapted to transmit a further beacon frame in the second slot in a subsequent superframe.

According to a third aspect of the invention, there is provided a network comprising at least one device as described above.

### BRIEF DESCRIPTION OF THE DRAWINGS

The invention will now be described in detail, by way of example only, with reference to the following drawings, in which:

FIG. 1 shows the arrangement of frequency bands in a Multi-Band Orthogonal Frequency Division Multiplexing (MB-OFDM) system for ultra-wideband communication;

FIG. 2 shows the basic timing structure of a superframe in a UWB system;

FIG. 3 illustrates the joining procedure for a plurality of devices in a Beacon Period for consecutive superframes;

FIG. 4 is a flow chart illustrating the steps in a method in accordance with the invention;

FIG. 5 shows a timeline for a joining procedure;

FIG. 6 illustrates the joining procedure for a plurality of devices in a Beacon Period in accordance with the invention;

FIG. 7 is a bar chart illustrating the improvements in reducing subsequent collisions using the method in accordance with the invention;

FIG. 8 is a line graph illustrating the differences between the method according to the invention and the prior art method; and

FIG. 9 is a line graph illustrating the difference in performance between the method according to the invention and the prior art method.

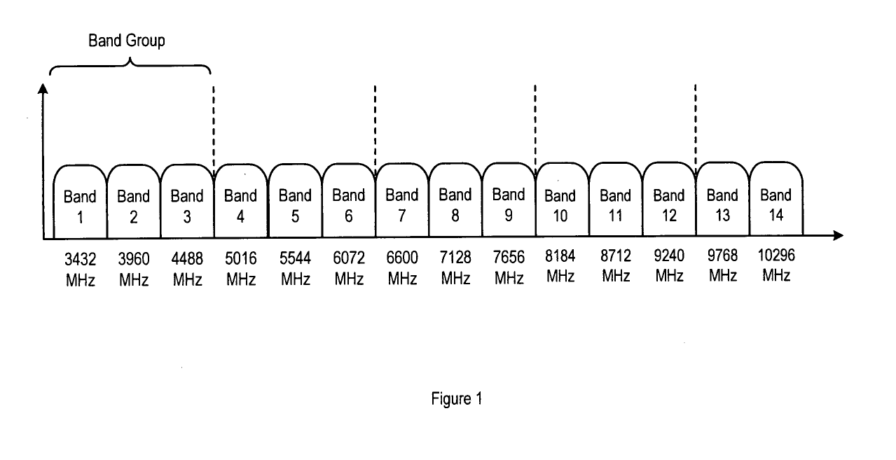

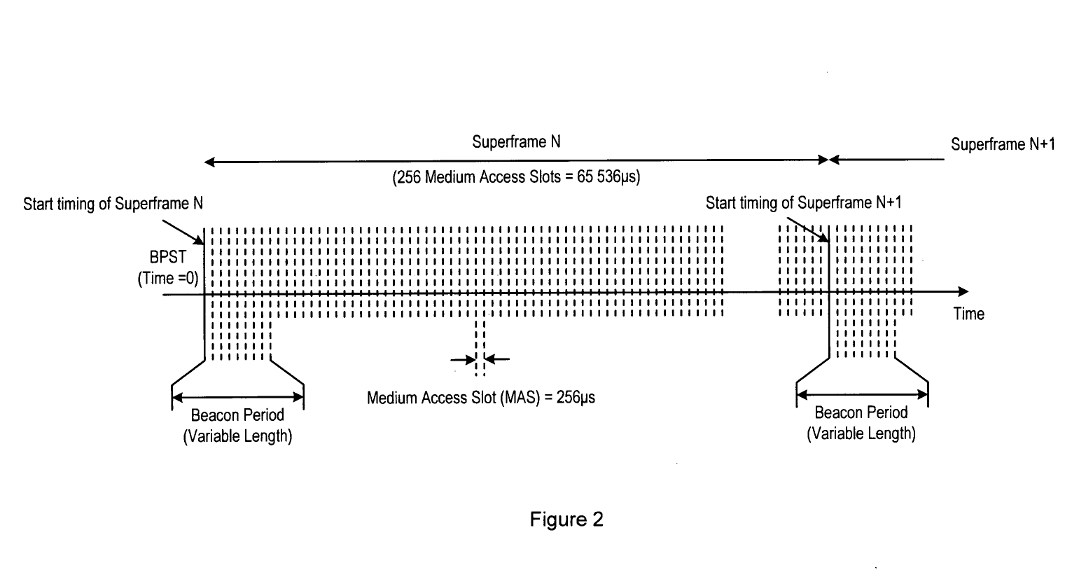

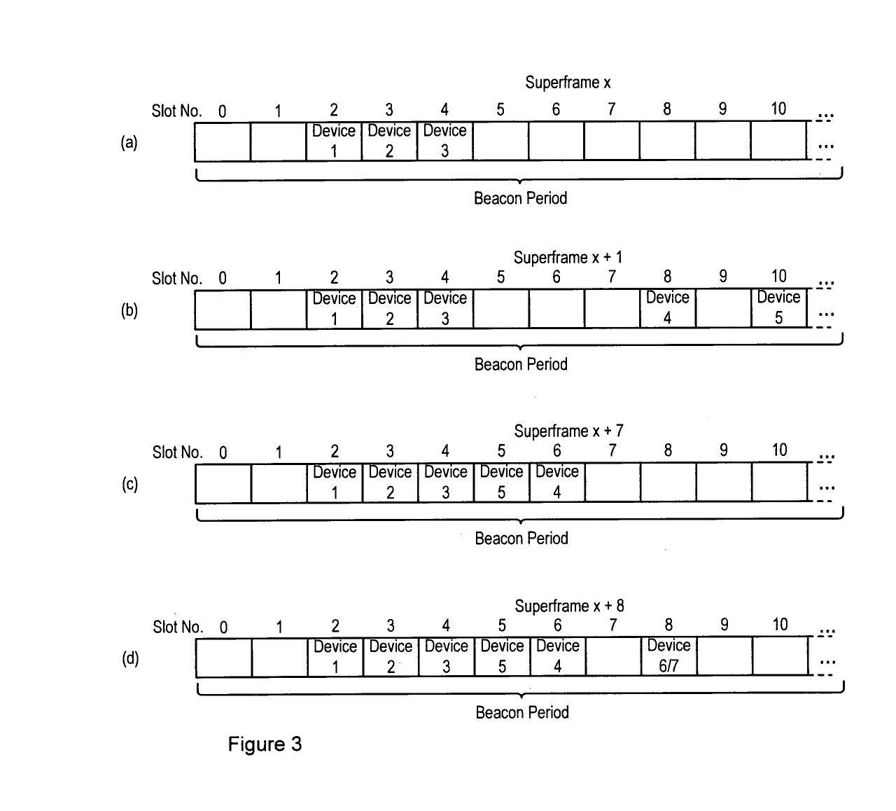

### DETAILED DESCRIPTION OF THE PREFERRED EMBODIMENTS

The invention will now be described with reference to an Ultra Wideband communications network, although it should be appreciated that the invention is applicable to other types of communication networks.

As described above, when new devices want to join a Beacon Group on a particular channel, they must listen for at least one superframe before they select an unallocated slot in the Beacon Period of the next superframe and transmit their Beacon frame in that slot.

If two or more devices select the same slot in the Beacon Period in which to transmit their Beacon frame, the Beacon frames will collide.

When such collisions are detected, the colliding devices are each required to redraw or reselect a slot for the subsequent superframe, in which they will transmit their Beacon frames. In accordance with the Ultra-Wideband standard, ECMA-368, the redrawn or reselected slot will be taken from a group of Beacon slots occurring after the last occupied Beacon slot. Thus, if the collision occurred in the tenth slot of a Beacon Period in a first superframe, the redrawn slot will be taken from a group of slots starting no earlier than the eleventh slot of the Beacon Period in a subsequent superframe. Thus, the tenth slot in the subsequent superframe, corresponding to the slot in the first superframe in which the collision occurred, is not used in the further attempts to join the network by either device.

Therefore, in the prior art procedures, any slots that are subject to contention and collisions are wasted during subsequent joining procedures by the colliding devices, as the slots are unallocated but unavailable for selection, until the Beacon Period contracts.

However, in accordance with the invention, after a collision has occurred in a particular Beacon slot, devices can redraw or reselect a Beacon slot from a group that includes the Beacon slot in which the collision occurred. The selection of the new Beacon slot can be made using any appropriate mechanism. In one embodiment, the selection of Beacon slot is random.

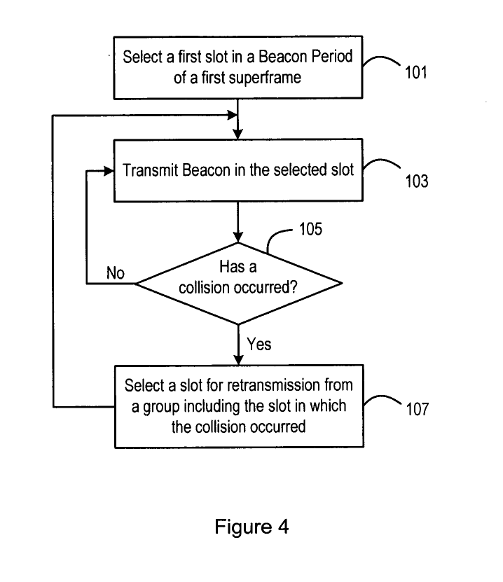

FIG. 4 is a flow chart illustrating the method in accordance with the invention. In step 101, a device wishing to join a network selects a Beacon slot in a Beacon Period in which to transmit a Beacon frame. As described above, this slot is selected from the group of slots occurring after the highest occupied slot in the Beacon Period. It should be noted that an “occupied” Beacon slot might not necessarily be allocated to another device in the network, but might simply indicate that activity within that slot is detected.

In step 103, the device transmits its Beacon frame in the selected slot.

If no collisions occur between the Beacon frame and frames from other devices (i.e. no other frames are transmitted in the selected Beacon slot), the method returns to step 103 in which the device continues to transmit its Beacon frame in the selected slot in subsequent superframes.

However, if a collision is detected between the Beacon frame and a frame or frames from other devices in the selected Beacon slot (step 105), the method passes to step 107.

A device can detect if a collision has occurred in accordance with the procedures set out in the ECMA-368 standard, and this detection might not necessarily occur in, or by, the next superframe.

In step 107, the colliding device selects another Beacon slot in which to transmit its Beacon frame. In accordance with the invention, the device selects the Beacon slot from a group of Beacon slots comprising the Beacon slot in which the collision occurred and at least one Beacon slot occurring after the Beacon slot in which the collision occurred. Preferably, the device selects the Beacon slot from a group comprising the Beacon slot in which the collision occurred and mBPExtension slots after the highest unavailable slot.

In this way, the Beacon slot in which the collision occurred is not necessarily wasted, as it is made available for Beacon frame retransmissions.

The method then loops back to step 103 in which the Beacon frame is transmitted in the selected slot of the next or a subsequent superframe.

If a further collision is detected in the selected slot between the Beacon frame and a frame from another device, the selecting procedure repeats (step 107), with the device being able to select a new slot from the group including a plurality of slots after the highest unavailable slot and the last selected slot.

Thus, in accordance with the invention, in any subsequent re-draw after an unsuccessful attempt to seize a slot, a device selects slots from amongst a window after the highest unavailable slot, plus the slot that it selected in its previous unsuccessful attempt. Therefore, for devices that are unsuccessful in their first attempt, the range of slots from which they make any subsequent attempt is increased by one in comparison to the conventional procedure.

Allowing devices to select slots in which collisions previously occurred results in significantly faster joining times for devices and more compact Beacon Periods. In addition, the invention allows for a higher number of devices to be accommodated before contraction is required due to more efficient utilisation of the slots.

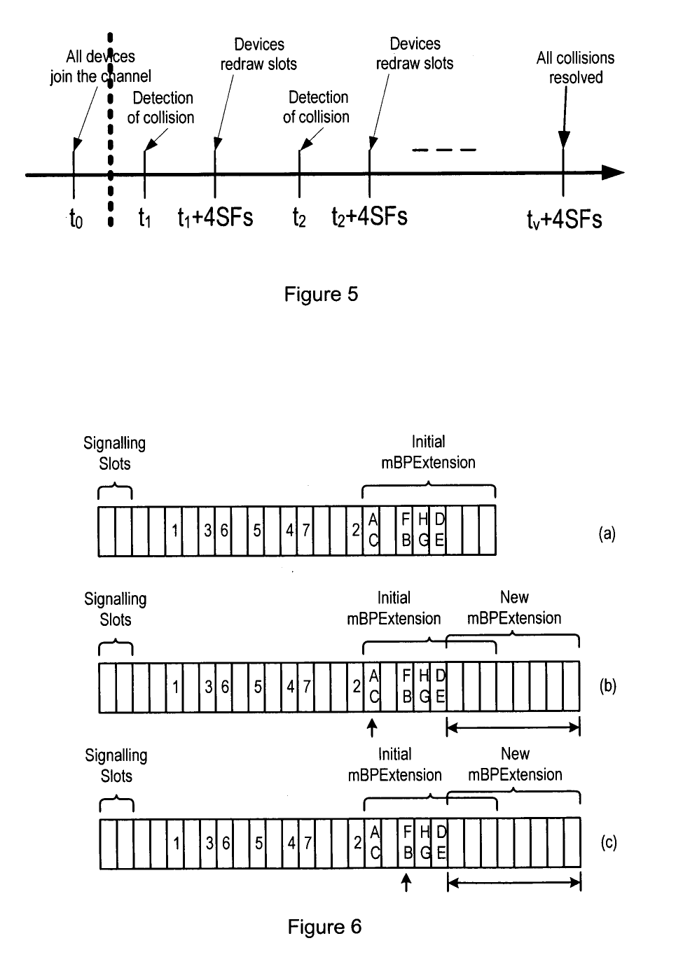

FIG. 5 shows a timeline of a joining procedure. As described above, before devices can join the target channel, they must scan it for at least one superframe before attempting to join. At time t₀, devices select unoccupied slots and “join” the channel. If collisions occur, colliding devices detect it at time t₁. At time t₁+4SFs (where 4SFs is the length of four superframes) these devices select a new slot from amongst the group comprising the mBPExtension window and the slot in which they previously collided. If a device again experiences contention/collision, the collision will be detected at time t₂ and devices will redraw slots at t₂+4SFs. The process is repeated until all devices have obtained a slot and all collisions have been resolved.

FIGS. 6(a)-(c) show a further illustration of the operation of the invention. In FIG. 6(a), a superframe is shown in which devices 1 to 7 transmit Beacon frames in a respective Beacon slot in the first 16 slots of the Beacon Period. New devices wishing the join the network (devices A-H) select a slot from the window of length mBPExtension starting from slot 17, which results in four separate collisions between the devices A-H in a first superframe.

FIG. 6(b) shows the Beacon slots available for redraw by devices A and C, which collided in slot 17 of the first superframe. Thus, devices A and C can select a new slot from the new window of length mBPExtension starting from slot 22 (after the last occupied slot in the first superframe) and the slot in which devices A and C collided (slot 17).

FIG. 6(c) shows the Beacon slots available for redraw by devices B and F, which collided in slot 19 of the first superframe. Thus, devices B and F can select a new slot from the new window of length mBPExtension starting from slot 22 (after the last occupied slot in the first superframe) and the slot in which devices B and F collided (slot 19).

The same applies to devices G and H, and D and E, which collided in Beacon slots 20 and 21 respectively.

The procedure according to the invention increases the chances of resolving collisions in a shorter time. In other words, it results in a higher probability of fewer collisions. The effect is cumulative and significant when larger numbers of devices (for example greater than 20) seek to simultaneously join a channel. When the probability of subsequent collisions is reduced, fewer collisions will occur and therefore the number of further redraws is reduced, which in return results in reduced time tᵥ.

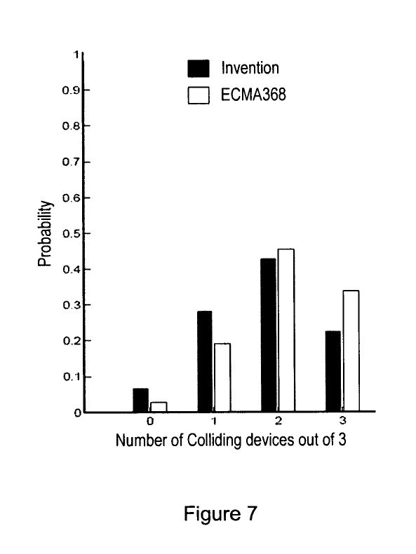

An example of the probability density function is shown in the bar graph of FIG. 7. In this example, a set of devices are divided into two groups, the first group including any devices that collided in a particular slot (in this example, assume three devices collided in a particular slot), and the second group including the remaining devices involved in collisions in that superframe and which have collided in slots other than the particular slot. FIG. 7 shows the probability of 0, 1, 2 and 3 of the devices from the first group colliding in a given superframe with any of the other devices (whether in the first group or second group) for procedures in accordance with ECMA-368 (represented by the hollow bars) and the invention (represented by the solid bars). Thus, it can be seen that the probability of fewer collisions (i.e. 0 or 1 collision) occurring between the devices is increased using the procedure according to the invention, while the probability of two or three of the devices colliding is lower using the procedure according to the invention.

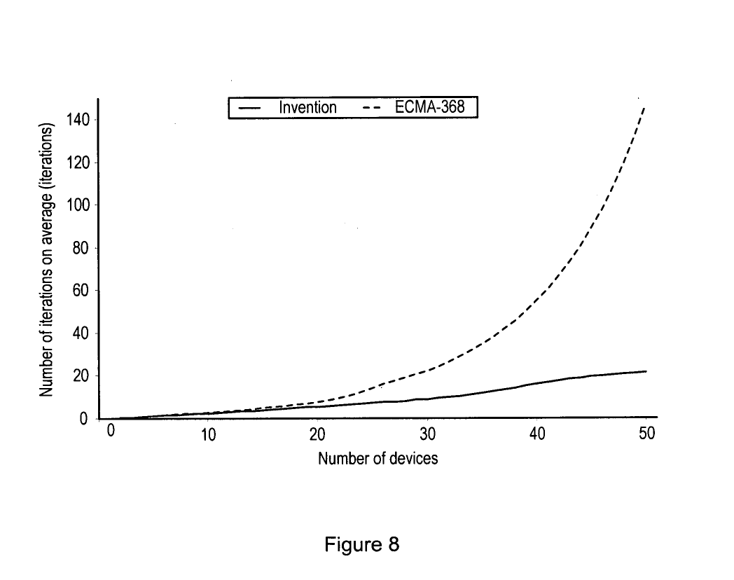

The graph in FIG. 8 shows how the average number of iterations (redraw attempts) required to join a network varies with an increasing number of devices for both the method according to the ECMA-368 standard and the method according to the invention. Thus, it can be seen that the number of iterations required in the conventional method (indicated by the dotted line) increases approximately exponentially with an increasing number of devices, while the method according to the invention results in the number of iterations rising approximately linearly with an increasing number of devices.

This graph illustrates that joining times for devices are improved by using the method in accordance with the invention.

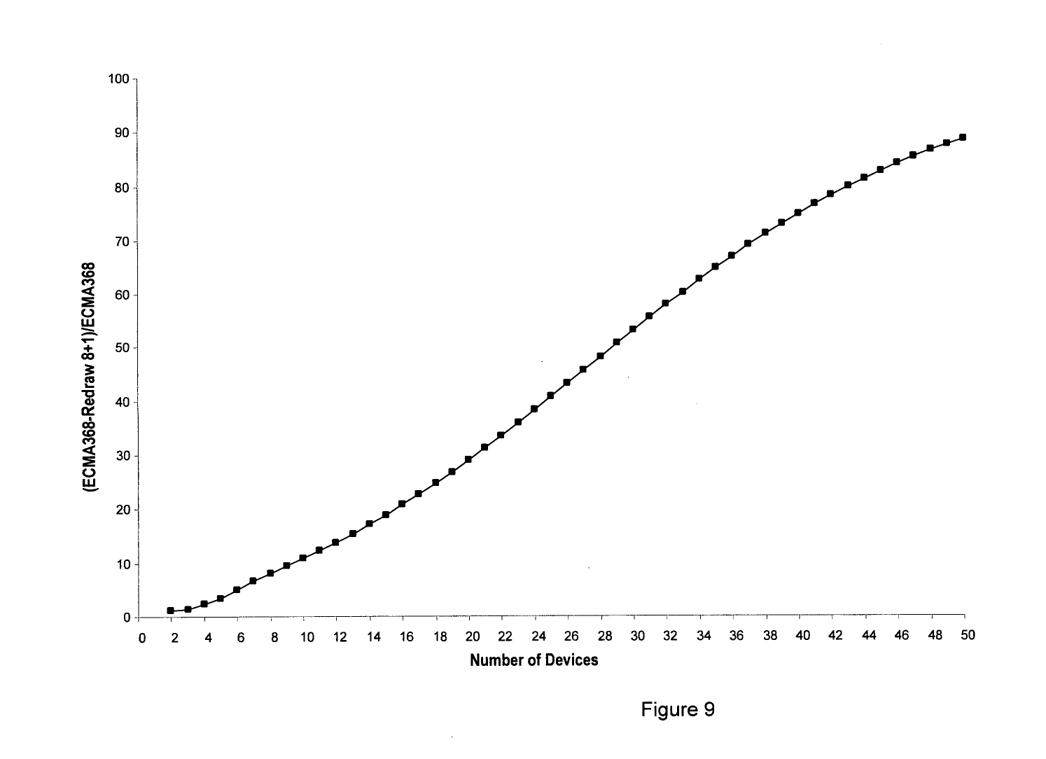

The graph in FIG. 9 plots the percentage improvement of the invention over the conventional method against the number of devices. Thus, it can be seen that as the number of devices joining increases, the improvement of using the method according to the invention increases. Even when the number of devices joining is in the range of 2-20, there is an improvement in the performance for the method according to the invention. When the number of devices increases to the range 20-50, the improvement over the prior art method is significant.

The invention results in a reduced joining time for dense networks. The time required to contract the Beacon Period is reduced because the method according to the invention allows the re-use of slots in the front section of the Beacon Period for subsequent redraws. The procedure is autonomous and each device operates independently of any other.

In addition, devices adapted to perform the procedure according to the invention are fully backwards compatible with devices that are not adapted to perform the procedure. Legacy ECMA-386 can co-exist seamlessly with devices supporting the procedure according to the invention. In fact, the presence of the inventive devices will improve the performance (in terms of joining latency) of standard ECMA-386 devices; since they themselves will experience a reduced probability of contention, which results in reduced latency.

1. A method of operating a device to join a network, the network having a plurality of superframes, each superframe being divided into slots, the method comprising:
transmitting a beacon frame in a first slot of a first superframe;
wherein, if a collision occurs in the first slot, selecting a second slot from a group comprising the first slot and a plurality of slots occurring after the first slot; and
transmitting a further beacon frame in the second slot in a subsequent superframe.

2. A method as claimed in claim 1, wherein the step of selecting the second slot comprises randomly selecting the second slot from the group comprising the first slot and a plurality of slots occurring after the first slot.

3. A method as claimed in claim 1, wherein the plurality of slots starts with the slot following the highest unavailable slot.

4. A method as claimed in claim 3, wherein the highest unavailable slot is the first slot or a slot occurring after the first slot.

5. A method as claimed in claim 1, wherein the plurality of slots comprise consecutive slots.

6. A method as claimed in claim 1, wherein the slots are part of a respective beacon period at the start of a superframe.

7. A method as claimed in claim 6, wherein the slots are beacon slots.

8. A method as claimed in claim 1, further comprising, if no collision occurs in the first or second slot, joining the network.

9. A method as claimed in claim 1, wherein, if a collision occurs in the second slot, selecting a third slot from a group comprising the second slot and a plurality of slots occurring after the second slot; and transmitting a further beacon frame in the third slot in a subsequent superframe.

10. A method as claimed in claim 1, wherein the collision in the first slot can be a collision between the beacon frame and a signal from another device.

11. A method as claimed in claim 10, wherein the signal from another device is a beacon frame for the other device.

12. A method as claimed in claim 1, wherein the step of transmitting comprises transmitting the further beacon frame in the second slot in the next superframe after the first superframe.

13. A device for use in a network, the network having a plurality of superframes, each superframe being divided into slots, the device comprising:
transmission means for transmitting a beacon frame in a first slot of a first superframe; and
selection means, responsive to detecting a collision in the first slot, for selecting a second slot from a group comprising the first slot and a plurality of slots occurring after the first slot;
wherein the transmission means is adapted to transmit a further beacon frame in the second slot in a subsequent superframe.

14. A device as claimed in claim 13, wherein the selection means is adapted to randomly select the second slot from the group comprising the first slot and the plurality of slots occurring after the first slot.

15. A device as claimed in claim 13, wherein the plurality of slots starts with the slot following the highest unavailable slot.

16. A device as claimed in claim 15, wherein the highest unavailable slot is the first slot or a slot occurring after the first slot.

17. A device as claimed in claim 13, wherein the plurality of slots comprise consecutive slots.

18. A device as claimed in claim 13, wherein the slots are part of a respective beacon period at the start of a superframe.

19. A device as claimed in claim 13, wherein the slots are beacon slots.

20. A device as claimed in claim 13, further comprising means, responsive to no collision occurring in the first or second slot, for joining the device to the network.

21. A device as claimed in claim 13, wherein the selection means is adapted to respond to a collision occurring in the second slot, by selecting a third slot from a group comprising the second slot and a plurality of slots occurring after the second slot; and wherein the transmission means is adapted to transmit a further beacon frame in the third slot in a subsequent superframe.

22. A device as claimed in claim 13, wherein the collision in the first slot is a collision between the beacon frame and a signal from another device.

23. A device as claimed in claim 22, wherein the signal from another device is a beacon frame for the other device.

24. A device as claimed in claim 13, wherein the transmission means is adapted to transmit the further beacon frame in the second slot in the next superframe after the first superframe.

25. A device as claimed in claim 13, wherein the device is adapted for use in an ultra wideband network.

26. A network, comprising at least one device as claimed in claim 13.
